(19) United States
(12) Patent Application Publication
(10) Pub. No.: US 2021/0230787 A1
(43) Pub. Date: Jul. 29, 2021

(54) WATER VALVE ASSEMBLY

(71) Applicant: WHIRLPOOL CORPORATION, BENTON HARBOR, MI (US)

(72) Inventors: Michael K. Cluskey, St. Joseph, MI (US); Alexandre Trevizan, Sorocaba SP (BR); Thiago Jorge Libanio Mendes, Itu SP (BR)

(73) Assignee: WHIRLPOOL CORPORATION, BENTON HARBOR, MI (US)

(21) Appl. No.: 17/155,160

(22) Filed: Jan. 22, 2021

Related U.S. Application Data
(60) Provisional application No. 62/966,606, filed on Jan. 28, 2020.

(51) Int. Cl. D06F 39/08; F16K 27/02

(52) U.S. Cl. CPC D06F 39/088; F16K 27/029

(57) ABSTRACT

A water valve assembly for a laundry appliance includes a body portion having first and second ends. A port is positioned at the first end of the body portion and is configured to be coupled with a water supply. An elongated nozzle extends from the second end of the body portion. The elongated nozzle defines a continuous channel in communication with an open end positioned to align with a top opening of a washtub. A retention feature is configured to receive a flow deflector. The body portion, the port, the elongated nozzle, and the retention feature are integrally formed as a single piece.

### CROSS-REFERENCE TO RELATED APPLICATION

This application claims priority to and the benefit under 35 U.S.C. § 119(e) of U.S. Provisional Application No. 62/966,606, filed on Jan. 28, 2020, entitled “WATER VALVE ASSEMBLY,” the disclosure of which is hereby incorporated herein by reference in its entirety.

### FIELD OF DISCLOSURE

The present disclosure generally relates to a water valve assembly, and more specifically, to an integrally formed water valve assembly for an appliance.

### BACKGROUND

Water valve assemblies for laundry appliances include ports configured to guide water from a water source into the appliance. The ports are often coupled with nozzles using gaskets and other seals to prevent leaks.

### SUMMARY OF THE DISCLOSURE

According to one aspect of the present disclosure, a water valve assembly includes a body portion having a first end and a second end. The body portion defines a valve receptacle at the first end. A port is positioned proximate the first end of the body portion and is configured to be coupled with a water supply. An elongated nozzle extends from the second end of the body portion. The elongated nozzle defines a continuous channel in communication with an open end. The body portion, the port, and the elongated nozzle are integrally formed as a single piece. A flap is operably coupled with the elongated nozzle by a living hinge.

According to another aspect of the present disclosure, a water valve assembly includes a body portion. The body portion includes a port configured to be coupled with a water supply. An elongated nozzle extends from the body portion. The elongated nozzle includes an open end. The body portion, the port, and the elongated nozzle are integrally formed as a single piece. An end adapter is operably coupled with the elongated nozzle at an integral retention feature of the open end to define a flow directing path Z.

According to yet another aspect of the present disclosure, a water valve assembly for a laundry appliance includes a body portion having first and second ends. A port is positioned at the first end of the body portion and is configured to be coupled with a water supply. An elongated nozzle extends from the second end of the body portion. The elongated nozzle defines a continuous channel in communication with an open end positioned to align with a top opening of a washtub. A retention feature is configured to receive a flow deflector. The body portion, the port, the elongated nozzle, and the retention feature are integrally formed as a single piece.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a laundry appliance;

FIG. 2 is a cross-section of the laundry appliance of FIG. 1 taken along line II-II;

FIG. 3 is a side perspective view of a water valve assembly, according to various examples;

FIG. 4 is a side profile view of the water valve assembly of FIG. 3;

FIG. 5 is a first side perspective view of a water valve assembly with an end adapter, according to various examples;

FIG. 6 is a second side perspective view of the water valve assembly of FIG. 5;

FIG. 7 is a side profile view of the water valve assembly of FIG. 5;

FIG. 8 is a side perspective view of the end adapter of FIG. 5, shown separated from the body portion;

FIG. 9 is a first side perspective view of a water valve assembly with an end adapter, according to various examples;

FIG. 10 is a second side perspective view of the water valve assembly of FIG. 9;

FIG. 11 is a side profile view of the water valve assembly of FIG. 9;

FIG. 12 is a side perspective view of the end adapter of FIG. 9;

FIG. 13 is a side perspective view of a water valve assembly with an end adapter, according to various examples;

FIG. 14 is an enlarged first side perspective view of the end adapter of FIG. 13;

FIG. 15 is an enlarged second side perspective view of the end adapter of FIG. 13;

and

FIG. 16 is an enlarged view of an attachment slot defined by the water valve assembly of FIG. 13.

The components in the figures are not necessarily to scale, emphasis instead being placed upon illustrating the principles described herein.

### DETAILED DESCRIPTION

The present illustrated embodiments reside primarily in combinations of method steps and apparatus components related to a water valve assembly for an appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

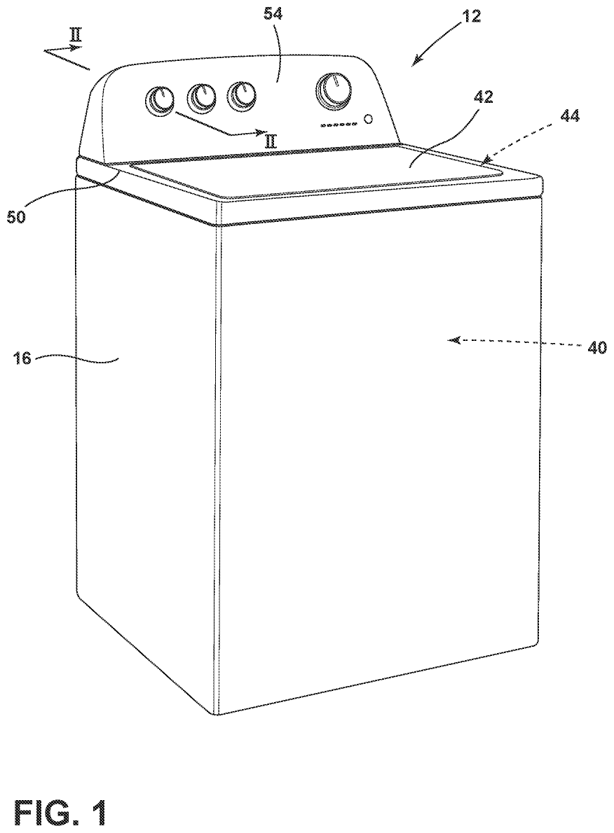

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

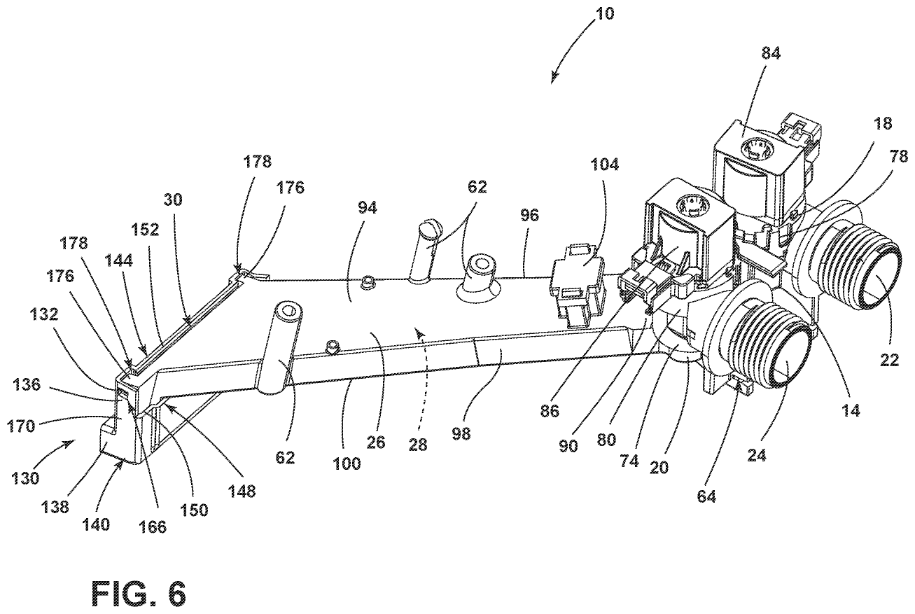

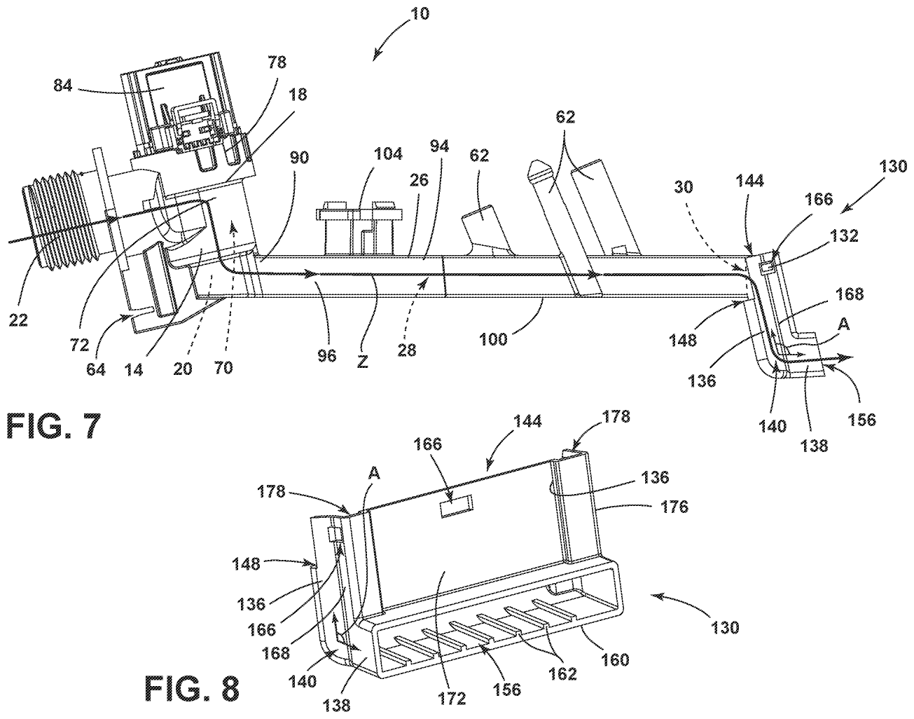

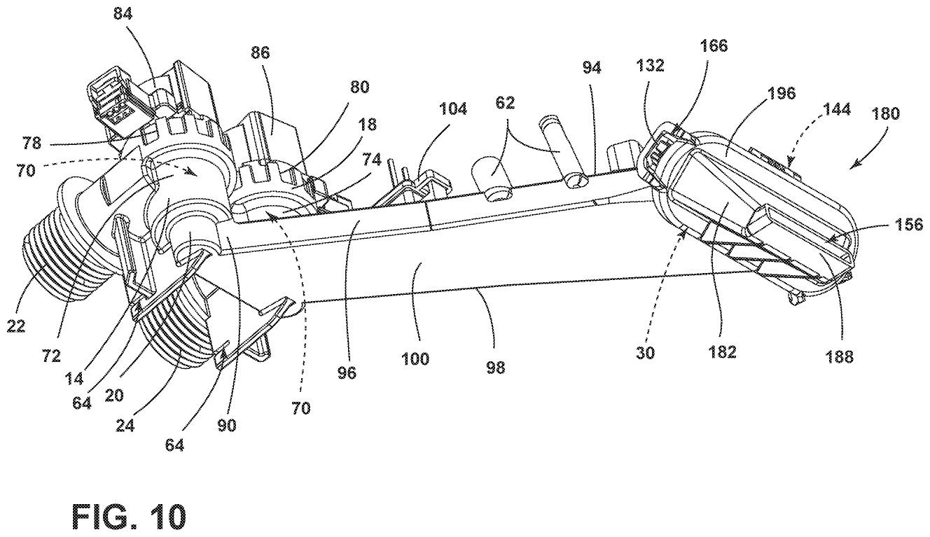

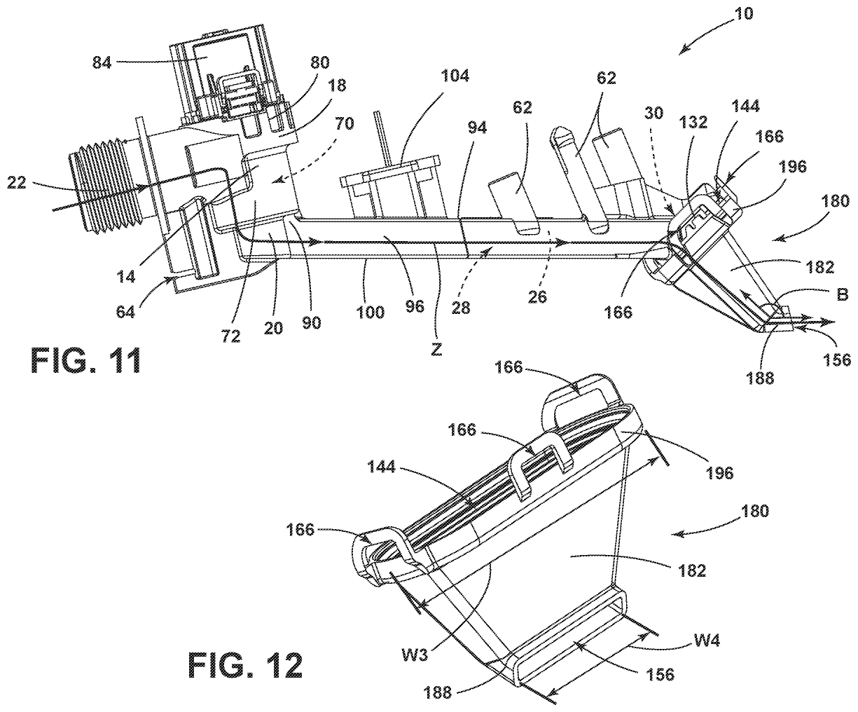

Referring now to FIGS. 1-16, reference numeral 10 generally designates a water valve assembly for an appliance 12. The water valve assembly 10 includes a body portion 14 coupled with a cabinet 16 and having first and second ends 18, 20. At least one port 22, 24 is positioned at the first end 18 of the body portion 14 and is configured to be coupled with a water supply. An elongated nozzle 26 extends from the second end 20 of the body portion 14 and away from the at least one port 22, 24. The elongated nozzle 26 defines a continuous channel 28 in communication with an open end 30. The body portion 14, the port 22, 24, and the elongated nozzle 26 are integrally formed as a single piece.

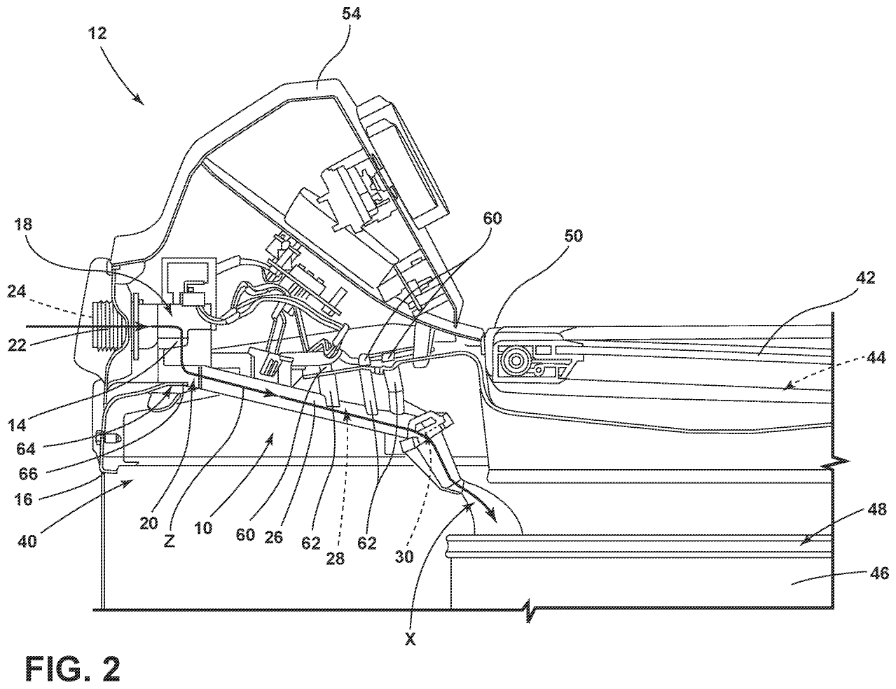

Referring now to FIGS. 1 and 2, the appliance 12 is illustrated as a washing machine including the water valve assembly 10. The appliance 12 includes the cabinet 16 defining a cavity 40. A washtub 46 is supported within the cavity 40 of the cabinet 16, and a lid 42 is configured to selectively close a top opening 44 of the cabinet 16. When the lid 42 is open, the top opening 44 allows a user access to the washtub 46 and/or the cavity 40. The washtub 46 includes an open top 48 aligned with the top opening 44 of the cabinet 16. The washtub 46 may be suspended from a top wall 50 of the cabinet 16 proximate the top opening 44 or may be supported from below or from the side of the cabinet 16. A display console 54 may be coupled with the top wall 50 of the cabinet 16 and may be configured to provide user input to the laundry appliance 12. However, it is contemplated that the display console 54 may be positioned on any portion of the cabinet 16, including, for example, the front of the cabinet 16, without departing from the scope of the present disclosure. It is further contemplated that the appliance 12 may also have other typical components of a laundry appliance such as motors, pumps, fluid lines, controls, sensors, transducers, etc.

Referring now to FIG. 2, the water valve assembly 10 is operably coupled with the cabinet 16 proximate the top wall 50 of the cabinet 16 such that the water valve assembly 10 is positioned above, and typically adjacent to, the open top 48 of the washtub 46. The water valve assembly 10 may be coupled with the cabinet 16 by fasteners, supports, adhesive, or any other coupling feature or combination thereof. For example, as illustrated in FIG. 2, the water valve assembly 10 may be coupled with the cabinet 16 using fasteners 60 received by, or integrally formed with, support extensions 62 of the water valve assembly 10. An attachment slot 64 is defined at the second end 20 of the body portion 14 of the water valve assembly 10 and is configured to cooperatively engage an aligning edge 66 of the cabinet 16. The engagement of the aligning edge 66 of the cabinet 16 with the attachment slot 64 aligns the water valve assembly 10 within the cabinet 16. When the water valve assembly 10 is coupled with, and aligned within, the cabinet 16, the ports 22, 24 may extend exterior of the cabinet 16 to be coupled with an external water source. Alternatively, the at least one port 22, 24 may be positioned interior of the cabinet 16 and may be accessible through an opening of the cabinet 16 without departing from the scope of the present disclosure. The open end 30 of the elongated nozzle 26 is positioned to provide a flow of water X from the open end 30 of the elongated nozzle 26 and into the open top 48 of the washtub 46. As introduced above, the water valve assembly 10 includes the body portion 14, the ports 22, 24, and the elongated nozzle 26 integrally formed as a single piece, as discussed in more detail below.

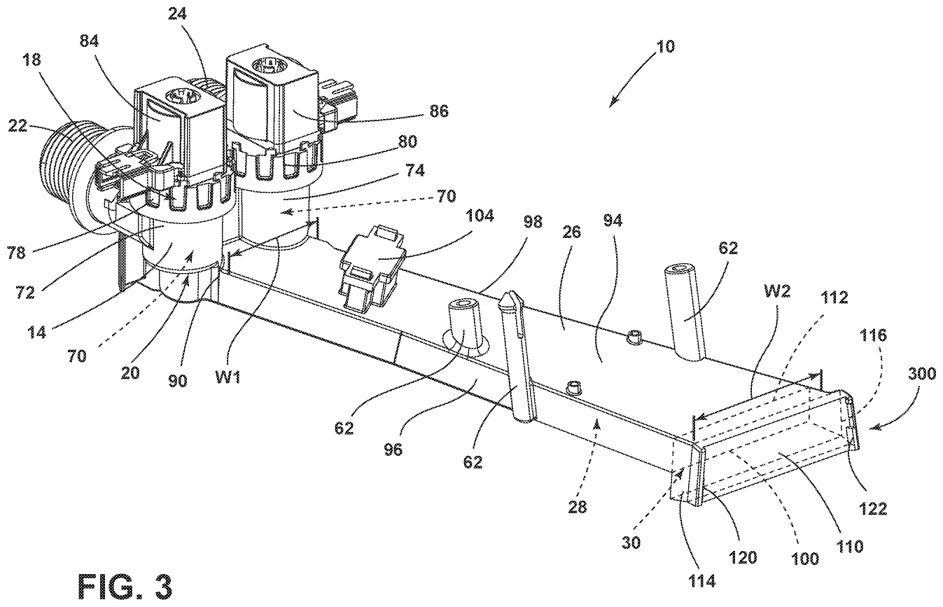

Referring now to FIG. 3, the water valve assembly 10 is illustrated according to various examples. The water valve assembly 10 includes the body portion 14, as introduced above. The body portion 14 includes the first end 18 and the second end 20 and defines an interior space 70. In various examples, the body portion 14 may be formed of first and second sections 72, 74. Each of the first and second sections 72, 74 is generally cylindrical in shape. However, it is contemplated that the first and second sections 72, 74 may have any shape configured to define the interior space 70 and may be the same or different shapes without departing from the scope of the present disclosure. It is further contemplated that the body portion 14 may be formed of a single portion or a plurality of portions without departing from the scope of the present disclosure.

The water valve assembly 10 further includes the at least one port 22, 24. The at least one port 22, 24 is positioned proximate the first end 18 of the body portion 14. Each port of the at least one port 22, 24 extends from one of the sections 72, 74 of the body portion 14. For example, as illustrated, the body portion 14 may include the first and second sections 72, 74 each integrally formed with a respective port 22, 24. Each of the ports 22, 24 may be an inlet port such that the first port 22 is a first inlet port and the second port 24 is a second inlet port. The first port 22 may be configured as a hot water port, and the second port 24 may be configured as a cold water port.

As illustrated in FIG. 2, when the water valve assembly 10 is coupled with the cabinet 16, the ports 22, 24 may extend exterior of the cabinet 16. The ports 22, 24 are each configured to be coupled with a water supply or source, such as a water line, and are configured to supply the flow of water X through the port 22, 24, into the body portion 14, and through the elongated nozzle 26 of the water valve assembly 10.

Referring again to FIG. 3, each of the sections 72, 74 of the body portion 14 defines one of first and second valve receptacles 78, 80 proximate the first end 18 of the body portion 14. It is contemplated that the sections 72, 74 of the body portion 14 may define the first and second valve receptacles 78, 80 as a single valve receptacle without departing from the scope of the present disclosure.

Each of the valve receptacles 78, 80 may be configured to receive a respective valve of first and second valves 84, 86 operably coupled with a respective port 22, 24. When the first and second valves 84, 86 are received by the first and second valve receptacles 78, 80, respectively, the valves 84, 86 are coupled with the body portion 14 of the water valve assembly 10. In various examples, each of the first and second valves 84, 86 may be configured as a solenoid valve. However, it is contemplated that each of the first and second valves 84, 86 may be any valve configured to selectively control a flow of water through the respective port 22, 24 without departing from the scope of the present disclosure.

Referring still to FIG. 3, the elongated nozzle 26 extends from the second end 20 of the body portion 14. A transition end 90 of the elongated nozzle 26 is coupled with the body portion 14 and is sized to extend across at least part of the body portion 14. The elongated nozzle 26 defines the continuous channel 28 in communication with the interior space 70 of the body portion 14. The channel 28 extends from the transition end 90 at the body portion 14 to the open end 30. The open end 30 is in communication with the channel 28 and is configured to direct the flow of water X from the body portion 14 into the washtub 46 of the appliance 12 (FIG. 2). In other words, the water valve assembly 10 is positioned to align the open end 30 of the elongated nozzle 26 with the open top 48 of the washtub 46 of the appliance 12.

The elongated nozzle 26 includes a top wall 94 extending between first and second sidewalls 96, 98. A bottom wall 100 also extends between the first and second sidewalls 96, 98 opposite the top wall 94. In various examples, the top wall 94 and the bottom wall 100 may be substantially parallel. In other examples, the top wall 94 and the bottom wall 100 may be formed to converge or diverge without departing from the scope of the present disclosure. At the transition end 90 proximate the body portion 14 of the water valve assembly 10, the elongated nozzle 26 has a first width W1. At the open end 30, the elongated nozzle 26 has a second width W2. In various examples, the elongated nozzle 26 may be generally tapered from the transition end 90 to the open end 30 such that the first width W1 is less than the second width W2. In other examples, the first and second widths W1, W2 may be substantially the same such that the elongated nozzle 26 has a substantially consistent width across the length of the elongated nozzle 26.

Referring again to FIG. 3, as introduced above, the body portion 14, the at least one port 22, 24, and the elongated nozzle 26 are integrally formed as a single unitary piece when the water valve assembly 10 is formed. For example, the body portion 14, the at least one port 22, 24, and the elongated nozzle 26 may be injection molded as a single piece using a single-shot molding process. It is possible to use this form of molding due to the shape and interconnections of the body portion 14, the at least one port 22, 24, and the elongated nozzle 26. Specifically, the shape and interconnections of the body portion 14, the at least one port 22, 24, and the elongated nozzle 26 are configured without sharp joining corners, which allows removal of the water valve assembly 10 from a single mold without the water valve assembly 10 catching on the mold. After the water valve assembly 10 is molded, other components, including, for example, the valves 84, 86 or a thermistor 104, may be coupled with the water valve assembly 10.

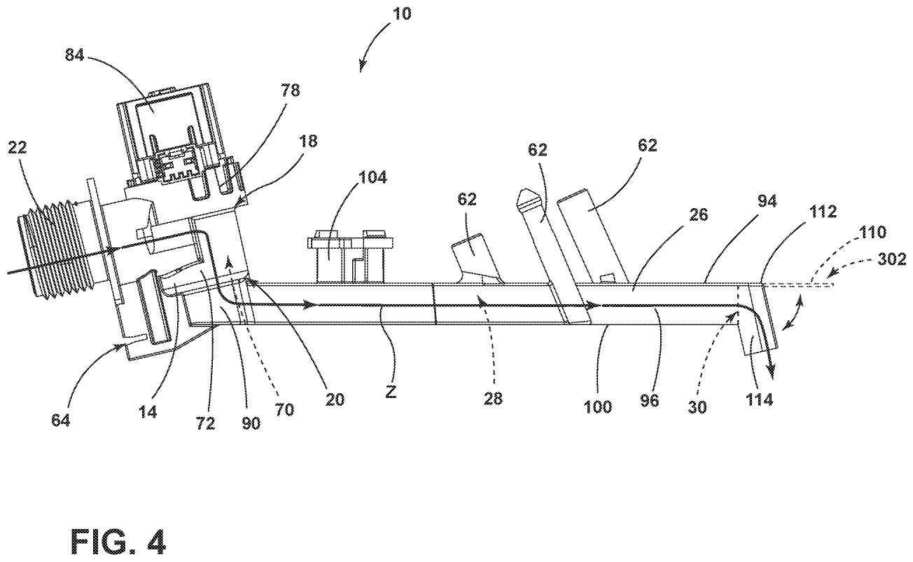

Referring now to FIGS. 3 and 4, the water valve assembly 10 is illustrated including a flap 110 integrally formed with the elongated nozzle 26. For example, the flap 110 may be integrally formed with the elongated nozzle 26 to be at least partially coupled with the open end 30 of the elongated nozzle 26 by a living hinge 112. First and second extensions 114, 116 extend from the first and second sidewalls 96, 98 of the elongated nozzle 26 and are positioned on opposing sides of the flap 110. When the water valve assembly 10 is formed, the living hinge 112 of the flap 110 is in an extended position 302 and is generally coplanar with, and parallel to, the top wall 94 of the elongated nozzle 26. As discussed above, this is possible because the water valve assembly 10 does not have internal corners that may require complex lifters or other complex forming mechanisms. The flap 110 is configured to rotate about the living hinge 112 and is movable between the extended position and a lowered position 300.

After molding, the flap 110 may be moved from the extended position 302 to the lowered position 300 and may be secured in the lowered position 300 by first and second tabs 120, 122. The first and second tabs 120, 122 define an integrally formed retention feature proximate the open end 30 of the elongated nozzle 26. When the flap 110 is in the lowered position 300, opposing edges of the flap 110 are positioned between the open end 30 of the elongated nozzle 26 and the first and second tabs 120, 122 such that the flap 110 is retained behind the first and second tabs 120, 122. The flap 110 is positioned so that the flap 110 and first and second sidewalls 96, 98 of the elongated nozzle 26 define a flow directing path Z configured to direct a flow of water from the open end 30. The flow directing path Z extends from the open end 30 of the elongated nozzle 26, along a rear surface of the flap 110, and out of the water valve assembly 10 so that the flow of water X is configured to be received by the open top 48 of the washtub 46 (FIG. 2).

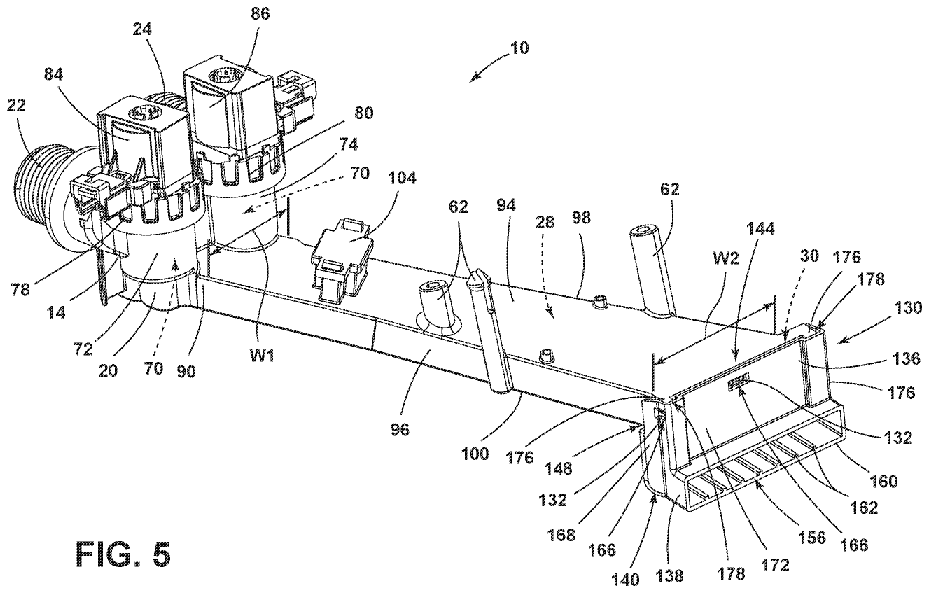

Referring now to FIGS. 5-7, the water valve assembly 10 is illustrated including a first end adapter 130, according to various examples. The elongated nozzle 26 is illustrated with the first end adapter 130, which has the same or similar components as described previously. Where the components are similar, the same numerals have been used. FIG. 8 illustrates the first end adapter 130 independent of the water valve assembly 10.

The first end adapter 130 may be removably coupled with the elongated nozzle 26 by a plurality of clips 132. The plurality of clips 132 is configured as an integral retention feature proximate the open end 30. Alternatively, the first end adapter 130 may be fixedly coupled with the elongated nozzle 26, for example, by adhesive or welding. It is contemplated that the first end adapter 130 may be positioned over the open end 30 of the elongated nozzle 26 such that the flap 110, secured in the lowered position 300 by the tabs 122, is enclosed by the first end adapter 130. It is also contemplated that the open end 30 of the elongated nozzle 26 may be formed without the flap 110 and may be configured to couple with the first end adapter 130 to define the flow directing path Z such that the flow directing path Z is configured to direct the flow of water from the elongated nozzle 26.

The first end adapter 130 includes a first portion 136 integrally formed with a second portion 138 to form an elbow 140.

The first portion 136 defines an upper opening 144 configured to act as an inlet for the flow directing path Z. The first portion 136 further defines a receiving space 148 in communication with the upper opening 144. The receiving space 148 is configured to at least partially receive the open end 30 of the elongated nozzle 26. When the open end 30 is received by the receiving space 148, the bottom wall 100 of the elongated nozzle 26 rests on a rear upper edge 150 of the first section 72, and the top wall 94 of the elongated nozzle 26 is generally aligned with a forward upper edge 152 of the first section 72. The second portion 138 of the first end adapter 130 defines a lower opening 156 configured to act as an outlet for the flow directing path Z. The positioning of the second portion 138 relative to the first portion 136 of the first end adapter 130 is configured to direct the flow of water X to flow into the open top 48 of the washtub 46 (FIG. 2).

As illustrated in FIGS. 5-8, the second portion 138 of the first end adapter 130 extends from the first portion 136 of the first end adapter 130 at an angle A. In various examples, the second portion 138 may be substantially perpendicular to the first portion 136. For example, the first and second portions 136, 138 of the first end adapter 130 may be formed such that the first end adapter 130 is generally L-shaped, as illustrated. L-shaped includes approximately L-shaped and various acute and obtuse angled that are similar in configuration to an L-shape. In other examples, the second portion 138 may be positioned at an acute or obtuse angle relative to the first portion 136 that is smaller or larger than an angle configured to be similar to an L-shape. For example, the first and second portions 136, 138 may be formed such that the first end adapter 130 is generally J-shaped, or may be formed such that the first end adapter 130 has any other shape that includes an elbow 140 configured to redirect the flow of water through the first end adapter 130.

In various examples, a lower wall 160 of the second portion 138 may include a plurality of ribs 162. The plurality of ribs 162 may extend along an interior surface of the lower wall 160 and may be oriented along the flow directing path Z and generally perpendicular perpendicularly to the lower opening 156. The plurality of ribs 162 may be configured to control the flow of water X along the flow directing path Z.

As introduced above, the plurality of clips 132 may be configured to operably couple the first end adapter 130 with the open end 30 of the elongated nozzle 26. For example, the plurality of clips 132 are formed by the elongated nozzle 26 proximate the open end 30. The plurality of clips 132 may be positioned about a periphery of the open end 30. The plurality of clips 132 are configured to engage with a plurality of retention spaces 166 defined by the first portion 136 of the first end adapter 130 proximate the upper opening 144. The plurality of retention spaces 166 may be oriented about a periphery of the upper opening 144 to correspond with the positioning of the plurality of clips 132 on the elongated nozzle 26. For example, first and second sidewalls 168, 170 of the first end adapter 130 may each define one or more of the plurality of retention spaces 166. A front wall 172 of the first end adapter 130 may also define one or more of the plurality of retention spaces 166. The plurality of retention spaces 166 are configured to engage with the plurality of clips 132 to define the integral retaining features proximate the open end 30 of the elongated nozzle 26. It is contemplated that the plurality of clips 132 and the plurality of retention spaces 166 may be positioned in any other arrangement or number without departing from the scope of the present disclosure.

Referring still to FIGS. 5-8, the elongated nozzle 26 may include one or more guides 176 extending from the elongated nozzle 26 proximate the open end 30 and configured to engage the first end adapter 130. The one or more guides 176 may be configured to be received by one or more corresponding receiving channels 178 defined by the first end adapter 130 and in communication with the upper opening 144. For example, as illustrated, the one or more receiving channels 178 may be defined by the front wall 172 of the first portion 136 of the first end adapter 130.

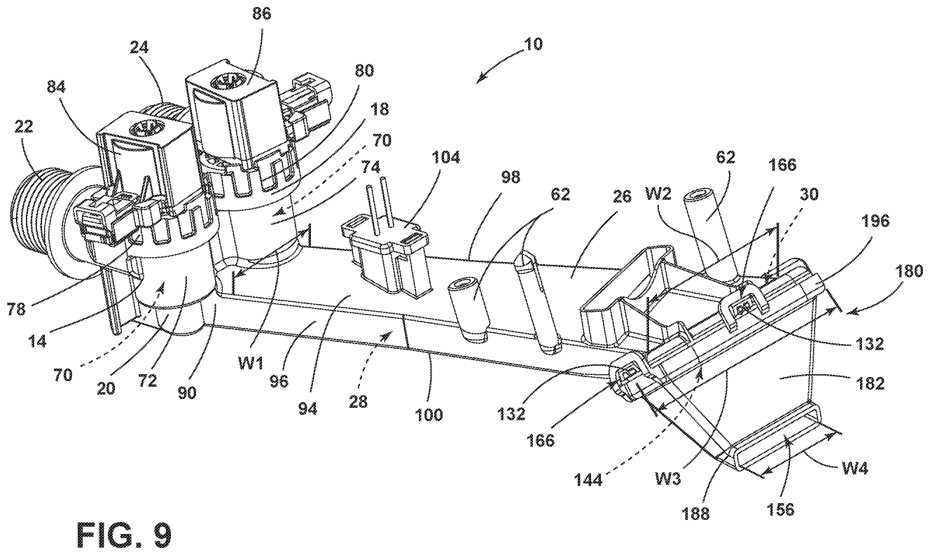

Referring now to FIGS. 9-11, a second end adapter 180 is illustrated coupled with the water valve assembly 10. The elongated nozzle 26 illustrated with the second end adapter 180 has the same or similar components as described previously. Where the components are similar, the same numerals have been used. FIG. 12 illustrates the second end adapter 180 independent of the water valve assembly 10.

Where the second end adapter 180 is used with the water valve assembly 10, the top wall 94 of the elongated nozzle 26 may extend further from the body portion 14 of the water valve assembly 10 than the bottom wall 100 of the elongated nozzle 26. This positions the open end 30 at an angle relative to the top wall 94 of the elongated nozzle 26, as discussed in more detail below.

The second end adapter 180 includes a body 182 that defines an upper opening 144 configured to act as the inlet for the flow directing path Z. The upper opening 144 may be configured to at least partially receive the elongated nozzle 26. In various examples, the body 182 of the second end adapter 180 may further define the lower opening 156. The lower opening 156 is configured to act as the outlet for the flow directing path Z and may be aligned with, or offset from, the upper opening 144. In other examples, a protrusion 188 may extend from a lower end of the body 182 and may be configured to define the lower opening 156. The protrusion 188 may be positioned at an angle B relative to the body 182. For example, the protrusion 188 may be substantially perpendicular to the body 182 or may be positioned at an acute or obtuse angle relative to the body 182.

The upper opening 144 defines an inlet width W3, and the lower opening 156 defines an outlet width W4. The inlet width W3 may be greater than the outlet width W4 such that the body 182 is tapered from the upper opening 144 to the lower opening 156. Alternatively, it will be understood that the inlet width W3 and the outlet width W4 may be substantially similar or the inlet width W3 may be less than the outlet width W4 without departing from the scope of the present disclosure.

As introduced above, where the second end adapter 180 is used with the water valve assembly 10, the open end 30 of the elongated nozzle 26 may be positioned at an angle relative to the top wall 94 of the elongated nozzle 26. The angle of the open end 30 relative to the top wall 94 of the elongated nozzle 26 is configured to allow the lower opening 156 of the second end adapter 180 to be aligned such that the flow directing path Z through the lower opening 156 is substantially parallel with the top wall 94 of the elongated nozzle 26.

The elongated nozzle 26 may include a plurality of clips 132 positioned on the first and second sidewalls 96, 98 and the top wall 94 of the elongated nozzle 26. The plurality of clips 132 may be positioned about a periphery of the open end 30 of the elongated nozzle 26 and are configured to engage with a plurality of retention spaces 166 defined by the second end adapter 180. The body 182 of the second end adapter 180 includes an upper rim 196. The upper rim 196 may define the plurality of retention spaces 166 configured to receive the plurality of clips 132. The plurality of retention spaces 166 are arranged to cooperatively engage with the plurality of clips 132 to define an integrally formed retention feature configured to couple the second end adapter 180 over the open end 30 of the elongated nozzle 26.

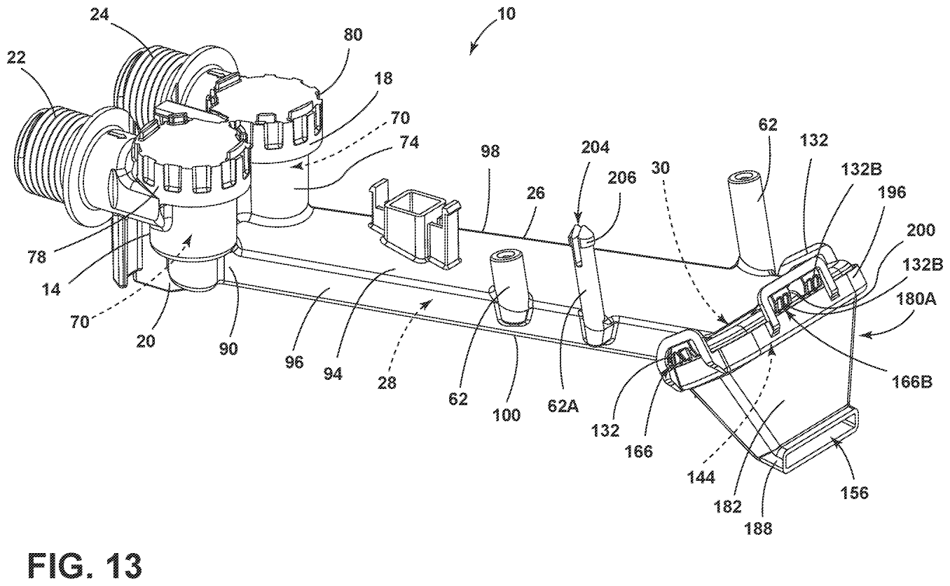

Referring now to FIGS. 13-16, the water valve assembly 10 is illustrated with a modified second end adapter 180A coupled with the water valve assembly 10. The elongated nozzle 26 illustrated with the modified second end adapter 180A has the same or similar components as described previously. Where the components are similar, the same numerals have been used.

Referring still to FIGS. 13-16, as described above, the top wall 94 of the elongated nozzle 26 may extend further from the body portion 14 of the water valve assembly 10 than the bottom wall 100 of the elongated nozzle 26. The modified second end adapter 180A includes the body 182 that defines the upper opening 144 and the lower opening 156. The protrusion 188 may extend from the lower end of the body 182 and may be configured to define the lower opening 156.

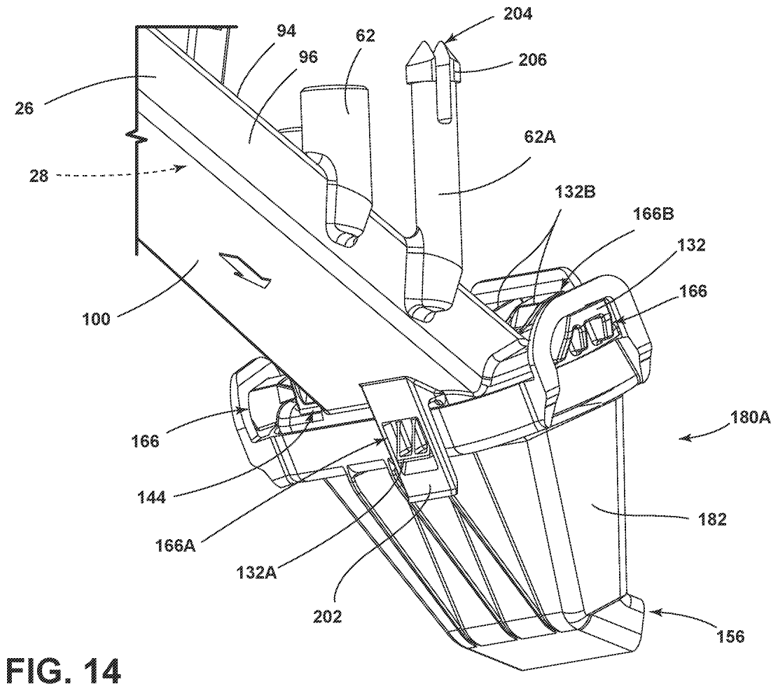

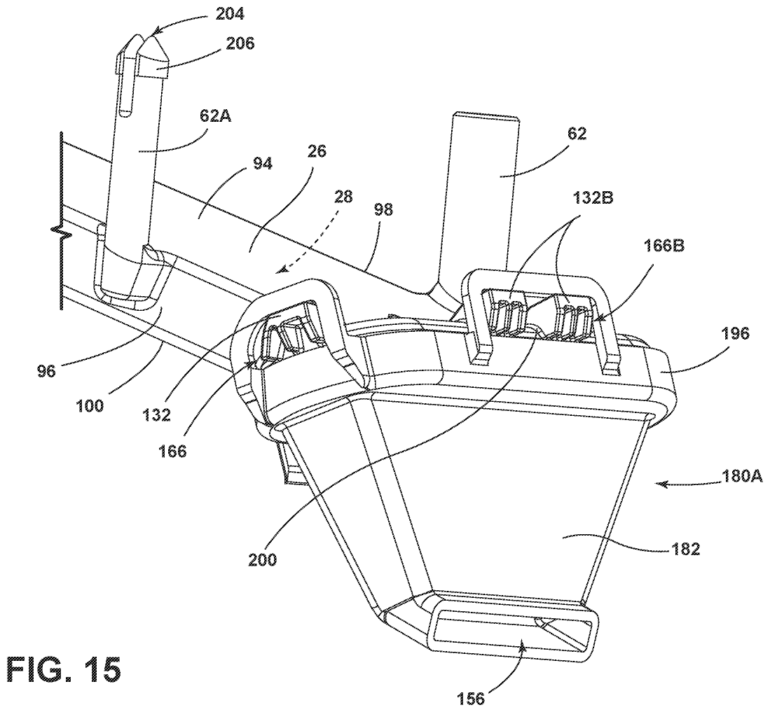

Referring now to FIGS. 14 and 15, the elongated nozzle 26 may include a plurality of clips 132 positioned on the first and second sidewalls 96, 98, the top wall 94, and/or the bottom wall 100 of the elongated nozzle 26. The plurality of clips 132 may include a rear clip 132A positioned on the bottom wall 100 of the elongated nozzle 26. The plurality of clips 132 may further include a front clip 132B defining a lip 200. In various examples, the plurality of clips 132 may include more than one front clip 132B. The plurality of clips 132 are configured to engage with a plurality of retention spaces 166 defined by the second end adapter 180.

As illustrated in FIG. 14, the rear clip 132A may be configured to engage with a rear retention space 166A of the plurality of retention spaces 166 defined by one or more protrusions 202 of the body 182 of the modified second adapter 180A. Further, as illustrated in FIG. 15, the front clip 132B is configured to engage with a front retention space 166B configured to engage with the lip 200 to secure the modified second adapter 180A with the elongated nozzle 26.

The body 182 of the modified second end adapter 180A includes the upper rim 196 that at least partially defines the plurality of retention spaces 166. The plurality of retention spaces 166 are arranged to cooperatively engage the plurality of clips 132 to define an integrally formed retention feature configured to couple the second end adapter 180 over the open end 30 of the elongated nozzle 26. It is contemplated that each of the plurality of clips 132 may include the lip 200 to couple the modified second adapter 180A with the elongated nozzle 26.

Referring again to FIGS. 13-15, in various examples, one of the support extensions 62A may define a slot 204 surrounded by a rim 206. The slot 204 may be sized to increase retention of the water valve assembly 10 when the support extension 62A is engaged with the cabinet 16 of the appliance 12. The rim 206 and the slot 204 form a resilient connection mechanism for engaging the cabinet 16. The support extension 62A may be configured to at least partially abut the cabinet 16 of the appliance 12 when the support extension 62A is engaged with the cabinet 16 to further couple the water valve assembly 10 with the cabinet 16 of the appliance 12. When the support extension 62A is engaged with the cabinet 16, the fasteners 60 may be coupled with the other support extensions 62 to couple the water valve assembly 10 with the cabinet 16.

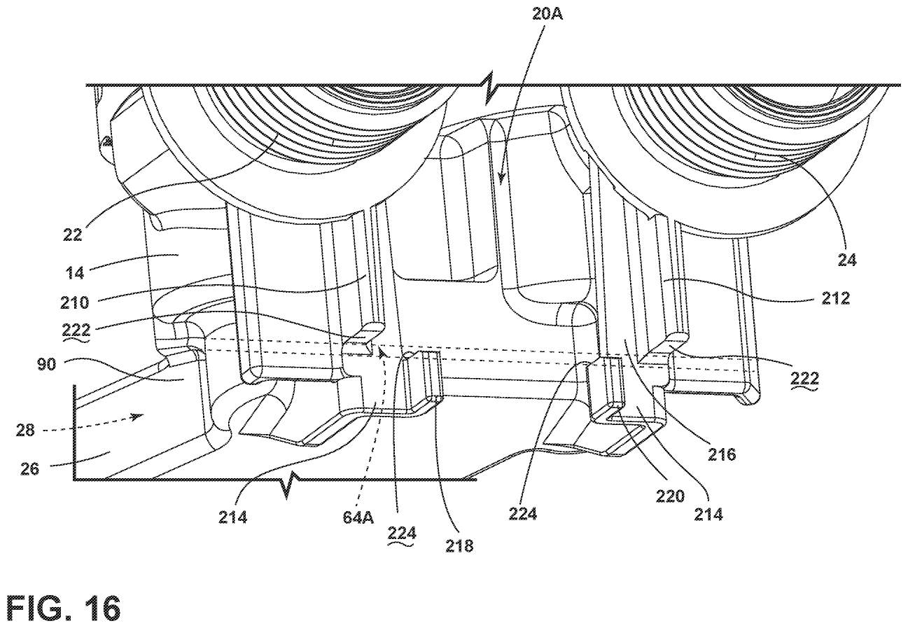

Referring now to FIG. 16, the body portion 14 of the water valve assembly 10 may include a modified second end 20A defining a modified attachment slot 64A. The modified second end 20A includes first and second side flanges 210, 212 extending downward from the nozzles 22, 24 toward a terminal end 214 of the second end 20A. The first and second side flanges 210, 212 are configured such that upper surfaces 222 of the first and second side flanges 210, 212 define the upper boundary of the modified attachment slot 64A.

A central flange 216 includes first and second central protrusions 218, 220 extending upward from the terminal end 214 of the modified second end 20A. The first and second central protrusions 218, 220 are positioned parallel with and are spaced apart from the first and second side flanges 210, 212 by the modified attachment slot 64A. The first and second central protrusions 218, 220 extend such that lower surfaces 224 of the first and second central protrusions 218, 220 define a lower boundary of the modified attachment slot 64A. The modified attachment slot 64A is defined by the upper and lower surfaces 222, 224 and is configured to guide the alignment of the water valve assembly 10 onto the alignment edge 66 when the water valve assembly 10 is coupled with the cabinet 16 of the appliance 12 (FIG. 2).

When the modified attachment slot 64A is engaged with the alignment edge 66 of the cabinet 16, the upper and lower surfaces 222, 224 are positioned to abut the alignment edge 66. In various examples, the upper and lower surfaces 222, 224 may be at least partially beveled to facilitate engagement of the modified attachment slot 64A with the alignment edge 66. The engagement of the modified attachment slot 64A with the alignment edge 66 acts as a locating feature for installing the water valve assembly 10 and may further act as a fulcrum for rotating the water valve assembly 10 into an installed position with respect to the cabinet 16.

Referring again to FIGS. 1-16, the water valve assembly 10 as disclosed allows water to flow X from the at least one port 22, 24, through the body portion 14 and the elongated nozzle 26, and into the washtub 46 while minimizing leaks. Because at least the body portion 14, the at least one port 22 and/or 24, and the elongated nozzle 26 are integrally formed, gaskets and other sealing members are not used to seal joints between these components, which minimizes the chance of failure and leaking around the joints. This provides a water valve assembly 10 that requires less maintenance and assembly while providing more leak protection for a consumer.

According to one aspect, a water valve assembly includes a body portion having a first end and a second end. The body portion defines a valve receptacle at the first end. A port is positioned proximate the first end of the body portion and is configured to be coupled with a water supply. An elongated nozzle extends from the second end of the body portion. The elongated nozzle defines a continuous channel in communication with an open end. The body portion, the port, and the elongated nozzle are integrally formed as a single piece. A flap is operably coupled with the elongated nozzle by a living hinge.

According to another aspect, an elongated nozzle has a first width proximate a body portion and a second width at an open end. The first width is less than the second width.

According to another aspect, a solenoid valve is attached to a body portion and is received by a valve receptacle.

According to another aspect, a port is one of first and second inlet ports. The first inlet port is a hot water port and the second inlet port is cold water port.

According to another aspect, a flap is secured in a lowered position by a retention feature of an open end of an elongated nozzle.

According to another aspect, a water valve assembly includes an end adapter operably coupled with an elongated nozzle and positioned over an open end and a flap.

According to another aspect, a water valve assembly includes a body portion including a port configured to be coupled with a water supply. An elongated nozzle extends from the body portion. The elongated nozzle includes an open end. The body portion, the port, and the elongated nozzle are integrally formed as a single piece. An end adapter is operably coupled with the elongated nozzle at an integral retention feature of the open end to define a flow directing path Z.

According to another aspect, an end adapter includes a first portion integrally formed with a second portion. The first portion defines an inlet of a flow directing path Z in communication with a receiving space. The receiving space is configured to at least partially receive an elongated nozzle.

According to another aspect, an end adapter is substantially L-shaped.

According to another aspect, an open end of an elongated nozzle is positioned at an angle relative to a top wall of the elongated nozzle.

According to another aspect, an end adapter includes a body defining an inlet of a flow directing path Z. A protrusion extends from the body parallel to an elongated nozzle. The protrusion defines an outlet of the flow-directing path.

According to another aspect, a body of an end adapter is configured to at least partially receive an elongated nozzle.

According to another aspect, an inlet of a flow directing path Z has an inlet width and an outlet of the flow directing path Z has an outlet width. The inlet width is greater than the outlet width.

According to another aspect, a water valve assembly for a laundry appliance includes a body portion having first and second ends. A port is positioned at the first end of the body portion and is configured to be coupled with a water supply. An elongated nozzle extends from the second end of the body portion. The elongated nozzle defines a continuous channel in communication with an open end positioned to align with a top opening of a washtub. A retention feature is configured to receive a flow deflector. The body portion, the port, the elongated nozzle, and the retention feature are integrally formed as a single piece.

According to another aspect, a flow deflector is one of an integral flap and an end adapter.

According to another aspect, a flow deflector is an integral flap that is operably coupled with an elongated nozzle by a living hinge.

According to another aspect, a flow deflector is an end adapter includes a first portion coupled with an elongated nozzle and a second portion positioned at an angle relative to the first portion.

According to another aspect, an end adapter is tapered away from an open end of an elongated nozzle.

According to another aspect, an end adapter is integrally formed with an elongated nozzle.

According to another aspect, a water valve assembly includes a valve operably coupled with a body portion and a port and is configured to selectively control a flow of water through the port.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A water valve assembly comprising:
a body portion having a first end and a second end, wherein the body portion defines a valve receptacle at the first end;
a port positioned proximate the first end of the body portion and configured to be coupled with a water supply;
an elongated nozzle extending from the second end of the body portion, wherein the elongated nozzle defines a continuous channel in communication with an open end, and further wherein the body portion, the port, and the elongated nozzle are integrally formed as a single piece; and
a flap operably coupled with the elongated nozzle by a living hinge.

2. The water valve assembly of claim 1, wherein the elongated nozzle has a first width proximate the body portion and a second width at the open end, the first width being less than the second width.

3. The water valve assembly of claim 1, wherein a solenoid valve is attached to the body portion and is received by the valve receptacle.

4. The water valve assembly of claim 1, wherein the port includes first and second inlet ports, and wherein the first inlet port is a hot water port and the second inlet port is cold water port.

5. The water valve assembly of claim 1, wherein the flap is secured in a lowered position by a retention feature of the open end of the elongated nozzle.

6. The water valve assembly of claim 1, further comprising:
an end adapter operably coupled with the elongated nozzle and positioned over the open end and the flap.

7. A water valve assembly comprising:
a body portion including a port configured to be coupled with a water supply;
an elongated nozzle extending from the body portion, wherein the elongated nozzle includes an open end, and wherein the body portion, the port, and the elongated nozzle are integrally formed as a single piece; and
an end adapter operably coupled with the elongated nozzle at an integral retention feature of the open end to define a flow directing path.

8. The water valve assembly of claim 7, wherein the end adapter includes a first portion integrally formed with a second portion, and further wherein the first portion defines an inlet of the flow directing path Z in communication with a receiving space, the receiving space configured to at least partially receive the elongated nozzle.

9. The water valve assembly of claim 8, wherein the end adapter is includes an angle.

10. The water valve assembly of claim 7, wherein the open end of the elongated nozzle is positioned at an angle relative to a top wall of the elongated nozzle.

11. The water valve assembly of claim 10, wherein the end adapter includes a body defining an inlet of the flow directing path Z and a protrusion extending from the body parallel to the elongated nozzle, wherein the protrusion defines an outlet of the flow-directing path.

12. The water valve assembly of claim 11, wherein the body of the end adapter is configured to at least partially receive the elongated nozzle.

13. The water valve assembly of claim 11, wherein the inlet of the flow directing path Z has an inlet width and the outlet of the flow directing path has an outlet width, the inlet width being greater than the outlet width.

14. A water valve assembly for a laundry appliance, comprising:
a body portion having first and second ends;
a port positioned at the first end of the body portion and configured to be coupled with a water supply;
an elongated nozzle extending from the second end of the body portion, wherein the elongated nozzle defines a continuous channel in communication with an open end positioned to align with a top opening of a washtub; and
a retention feature configured to receive a flow deflector, wherein the body portion, the port, the elongated nozzle, and the retention feature are integrally formed as a single piece.

15. The water valve assembly of claim 14, wherein the flow deflector is one of an integral flap and an end adapter.

16. The water valve assembly of claim 15, wherein the flow deflector is the integral flap that is operably coupled with the elongated nozzle by a living hinge.

17. The water valve assembly of claim 15, wherein the flow deflector is the end adapter that includes a first portion coupled with the elongated nozzle and a second portion positioned at an angle relative to the first portion.

18. The water valve assembly of claim 15, wherein the end adapter includes an upper opening configured to at least partially receive the elongated nozzle, and the end adapter is tapered from the upper opening to a lower opening.

19. The water valve assembly of claim 15, wherein the end adapter is integrally formed with the elongated nozzle.

20. The water valve assembly of claim 15, further comprising:
a valve operably coupled with the body portion and the port and configured to selectively control a flow of water through the port.
